(19) United States
(12) Patent Application Publication
(10) Pub. No.: US 2010/0146577 A1
(43) Pub. Date: Jun. 10, 2010

(54) RECEPTION SYSTEM FOR DIGITAL MULTIMEDIA BROADCASTING AND METHOD THEREOF

(75) Inventor: Jae Kyu Cho, Seoul (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/535,132

(22) Filed: Aug. 4, 2009

(30) Foreign Application Priority Data
Dec. 4, 2008 (KR) 10-2008-122565

(51) Int. Cl. H04N 7/173

(52) U.S. Cl. 725/127

(57) ABSTRACT

The present invention relates to a digital multimedia broadcasting reception system and method, and in particular to, a technology for transmitting a digital multimedia broadcasting signal received in a tuner to a head unit without a compression process.

### CROSS-REFERENCE TO RELATED APPLICATION

This application claims under 35 U.S.C. §119(a) the benefit of Korean Patent Application No. 10-2008-122565 filed Dec. 4, 2008, the entire contents of which are incorporated herein by reference.

### BACKGROUND OF THE INVENTION

The present invention relates to systems and methods for receiving digital multimedia broadcasting.

FIG. 1 is a block diagram showing a preferred configuration of a conventional reception system for digital multimedia broadcasting.

As shown in FIG. 1, the conventional reception system for digital multimedia broadcasting 1 preferably includes a tuner 10 and a head unit 20.

According to the conventional reception system, the tuner 10 preferably includes a RF module 11 that suitably receives a digital multimedia broadcasting signal through an antenna, a DMB codec 12 that suitably receives the digital multimedia broadcasting signal from the RF module 11 and separately extracts a video signal and an audio signal, a MPEG encoder 13 that compresses the separately extracted video and audio signal with a MPEG format, a controller 14 that suitably receives a transmission start request signal from the head unit 20 and suitably allocates a channel necessary for the transmission of broadcasting signal among channels of a MOST transceiver 15, where the MOST transceiver 15 suitably sends the broadcasting signal compressed with the MPEG format to an optical transceiver 16 through the allocated channel, and the optical transceiver 16 suitably converts the broadcasting signal compressed with the MPEG format into an optical signal and suitably sends the signal to the head unit 20.

Preferably, the head unit 20 includes an optical transceiver 21 that suitably receives the broadcasting signal that is suitably compressed with the MPEG format from the optical transceiver 16 of the tuner 10, a controller 22 that suitably receives a channel allocation confirmation signal from the controller of the tuner and allocates a channel necessary for the transmission of broadcasting signal among channels of MOST transceiver 23, a MOST transceiver 23 that suitably sends the broadcasting signal compressed with the MPEG format to a MPEG codec, a MPEG codec 26 that suitably decompresses the broadcasting signal compressed with the MPEG format and sends a decompressed video signal to a graphics controller 24 and sends a decompressed audio signal to a speaker 25 through the MOST transceiver 23, and a graphics controller 24 that suitably displays the video signal through a display unit 27.

Preferably, in certain cases, the MOST transceiver 15 of the tuner 10 does not directly send the digital multimedia broadcasting signal to the MOST transceiver 23 of the head unit 20 but sends with the compressed MPEG format.

Accordingly, the digital multimedia broadcasting signal that the RF module 11 received through an antenna is comprised of a variable bit rate, and the bit rate preferably changes according to time. However, since the MOST transceiver 15 is preferably made according to MOST25 protocol, in view of its preferred specifications, it is impossible to suitably transmit a variable bit rate, and only possible to suitably transmit a constant bit rate. Accordingly, the tuner 10 should preferably convert the digital multimedia broadcasting signal that the RF module preferably received through the antenna into a suitable broadcasting signal having a constant bit rate through the MPEG codec and transmit to the head unit 20, and then, the head unit 20 should preferably decode this into a digital multimedia broadcasting signal of a variable bit rate through the MPEG encoder. Accordingly, there is a problem in that the deterioration of picture quality occurs and the loss of data results during the process where the tuner 10 compresses the digital multimedia broadcasting signal through the MPEG codec.

The above information disclosed in this the Background section is only for enhancement of understanding of the background of the invention and therefore it may contain information that does not form the prior art that is already known in this country to a person of ordinary skill in the art.

### SUMMARY OF THE INVENTION

The present invention provides a digital multimedia broadcasting reception system and a method for transmitting a digital multimedia broadcasting signal of variable bit rate that a tuner received from a broadcast station to a head unit without a compression process for constant bit rate.

According to a preferred embodiment of the present invention, a reception system for digital multimedia broadcasting preferably comprises a tuner that sends a digital multimedia broadcasting signal made of variable bit rate suitably received from a broadcast station through a MOST transceiver, and a head unit that separately extracts a video signal and an audio signal from the digital multimedia broadcasting signal of variable bit rate transmitted from the tuner, and then suitably outputs the video signal and the audio signal.

In accordance with another preferred embodiment of the present invention, the tuner preferably includes a RF module that suitably receives the digital multimedia broadcasting signal made of variable bit rate from the broadcast station through an antenna; a controller that suitably receives a transmission start request signal of digital multimedia broadcasting signal from the head unit and allocates a plurality of stream channels to a MOST transceiver for the transmission of the digital multimedia broadcasting signal and generates a channel allocation confirmation signal; a MOST transceiver that suitably sends the digital multimedia broadcasting signal of variable bit rate received in the RF module to an optical transceiver by using the stream channel allocated by the controller; and an optical transceiver that suitably converts the digital multimedia broadcasting signal transmitted from the MOST transceiver into an optical signal and sends to the head unit.

In accordance with another preferred embodiment of the present invention, the head unit suitably includes an optical transceiver that preferably receives the digital multimedia broadcasting signal converted into an optical signal from the optical transceiver of the tuner in order to suitably convert the digital multimedia broadcasting signal into an electrical digital multimedia broadcasting signal; a controller that preferably sends a transmission start request for a digital multimedia broadcasting signal to the tuner and receives a channel allocation confirmation signal according to the transmission start request and allocates a plurality of stream channels to the MOST transceiver for the transmission of the digital multimedia broadcasting signal; a MOST transceiver that suitably receives a digital multimedia broadcasting signal from the optical receiver; an unified codec that separately extracts an audio signal and a video signal from the digital multimedia broadcasting signal transmitted from the MOST transceiver; a graphics controller that suitably receives the video signal from the unified codec and outputs the video signal by using a monitor, wherein the MOST transceiver suitably receives the audio signal from the unified codec and sends the audio signal to a speaker through an optical transceiver.

In accordance with a further preferred embodiment of the present invention, the MOST transceiver preferably includes a plurality of stream channels that suitably transmit the digital multimedia broadcasting signal; and a control channel that preferably sends a transmission start request signal and a channel allocation completion signal which is suitably generated as the controller allocates a stream channel to the MOST transceiver.

In accordance with preferred exemplary embodiments of the present invention, the MOST transceiver is preferably made of a MOST 150 protocol.

According to certain preferred embodiment of the present invention, a receiving method for digital multimedia broadcasting preferably includes: (a) sending a digital multimedia broadcasting signal made of variable bit rate suitably received from a broadcast station by making use of a MOST transceiver by a tuner; and (b) separately extracting a video signal and an audio signal from the digital multimedia broadcasting signal of variable bit rate suitably transmitted from the tuner, and then outputs the video signal and the audio signal by a head unit.

In accordance with another preferred embodiment of the present invention, the MOST transceiver is preferably made of a MOST 150 protocol. In accordance with still other preferred embodiments of the present invention, the step (a) preferably includes: (a-1) suitably receiving a transmission start request for digital multimedia broadcasting signal from the head unit; (a-2) suitably allocating a plurality of stream channels to the MOST transceiver for the transmission of the digital multimedia broadcasting signal and generating a channel allocation confirmation signal; (a-3) suitably receiving a digital multimedia broadcasting signal made of variable bit rate from the broadcast station through an antenna; and (a-4) optically transmitting the received digital multimedia broadcasting signal of variable bit rate to the head unit by using the stream channel of MOST transceiver which is allocated by the controller. In accordance with another preferred embodiment of the present invention, the step (b) preferably includes: (b-1) sending a transmission start request signal for digital multimedia broadcasting signal to the tuner; (b-2) suitably allocating a plurality of stream channels to the MOST transceiver for the transmission of the digital multimedia broadcasting signal; (b-3) suitably receiving a digital multimedia broadcasting signal converted into an optical signal from an optical transceiver of the tuner through a stream channel of MOST transceiver and converting the digital multimedia broadcasting signal into an electrical digital multimedia broadcasting signal; (b-4) separately extracting an audio signal and a video signal from the electrical digital multimedia broadcasting signal; and (b-5) suitably outputting the video signal by using a monitor and sending the audio signal to a speaker.

Preferably, the reception system and method for digital multimedia broadcasting of the present invention transmits a digital multimedia broadcasting signal consisting of variable bit rate received from the broadcast station to the head unit by using the MOST transceiver using a MOST150 protocol without the compression for constant bit rate. Accordingly, the deterioration of picture quality and the loss of data according to the compression into the constant bit rate of the digital multimedia broadcasting signal can be prevented.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a block diagram showing a preferred configuration of a conventional reception system for digital multimedia broadcasting.

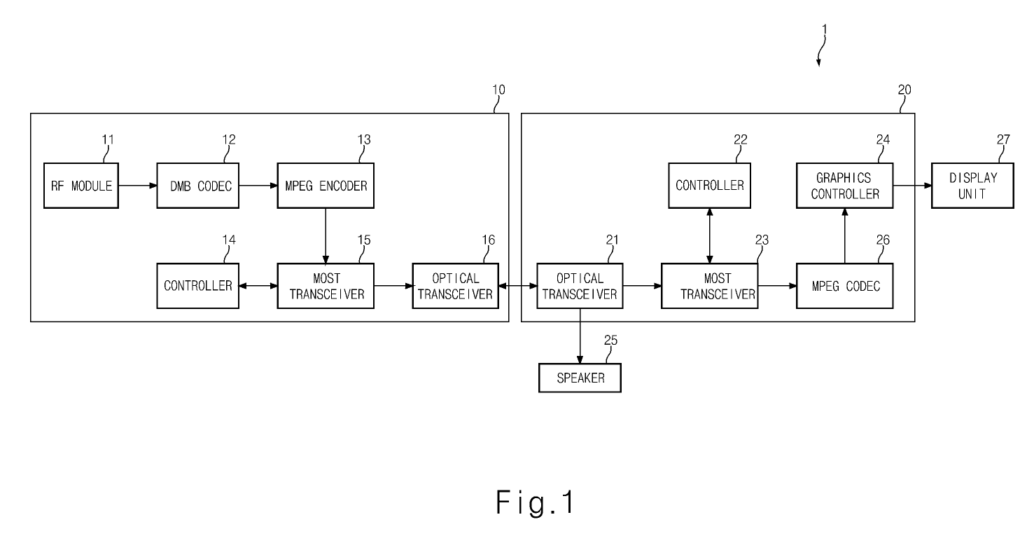

FIG. 2 is a block diagram showing a preferred configuration of reception system for digital multimedia broadcasting of the present invention.

FIG. 3 is a flowchart showing a method of receiving a digital multimedia broadcasting according to preferred embodiments of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

In one aspect, the present invention features a reception system for digital multimedia broadcasting, comprising a tuner, wherein the tuner sends a digital multimedia broadcasting signal made of variable bit rate through a MOST transceiver; and a head unit.

In one embodiment, the variable bit rate is received from a broadcast station through a MOST transceiver.

In another embodiment, the head unit separately extracts a video signal and an audio signal from the digital multimedia broadcasting signal of variable bit rate transmitted from the tuner, and outputs the video signal and the audio signal.

In another aspect, the invention features a receiving method for digital multimedia broadcasting, the receiving method comprising (a) sending a digital multimedia broadcasting signal made of variable bit rate received from a broadcast station by making use of a MOST transceiver by a tuner, and (b) separately extracting a video signal and an audio signal from the digital multimedia broadcasting signal of variable bit rate transmitted from the tuner, and outputs the video signal and the audio signal by a head unit.

The invention also features a motor vehicle comprising the a reception system for digital multimedia broadcasting.

Hereinafter, exemplary embodiments of the present invention will be described in detail with reference to the attached drawings

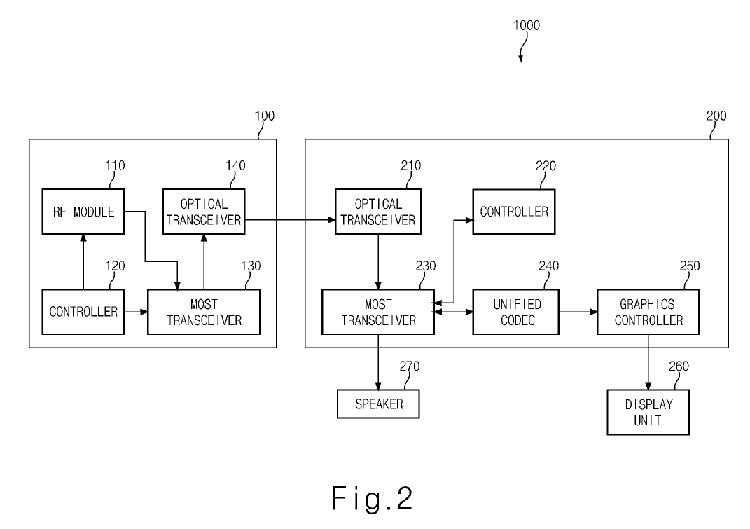

FIG. 2 is a block diagram showing a preferred configuration of a reception system for digital multimedia broadcasting 1000 according to certain preferred embodiments of the present invention.

As shown in FIG. 2, for example, the reception system for digital multimedia broadcasting 1000 of the present invention preferably includes a tuner 100 and a head unit 200. In certain preferred embodiment, the tuner 100 includes, but may not only be limited to, a RF module 110, a controller 120, a MOST transceiver 130 and an optical transceiver 140.

In further preferred embodiments, the RF module 110 suitably receives a digital multimedia broadcasting signal from a digital multimedia broadcasting station preferably through an antenna. Preferably, the digital multimedia broadcasting signal is made of broadcasting signal, for example, H264 codec which is made of variable bit rate (VBR) that the amount of outputted data per hour is continuously changed.

According to other further preferred embodiments, the controller 120 suitably receives a transmission start request for a digital multimedia broadcasting signal from the head unit 200. According to the transmission start request, the controller 120 preferably allocates a plurality of stream channels for the transmission of digital multimedia broadcasting signal among channels of a MOST transceiver 130. Preferably, the MOST transceiver 130 includes a plurality of stream channels that suitably transmit the digital multimedia broadcasting signal and a control channel that suitably sends a control signal.

Accordingly, in further preferred embodiments, the controller 120 suitably receives the transmission start request from the head unit 200 through the control channel of a preferred MOST protocol and then suitably allocates a plurality of stream channels for the transmission of the digital multimedia broadcasting signal. Further, in the case of allocating the stream channel to the MOST transceiver 130, the controller 120 suitably generates a channel allocation completion signal and sends to the head unit 200 through the control channel of MOST transceiver 130.

According to further preferred embodiments of the present invention, the MOST transceiver 130 sends the digital multimedia broadcasting signal of variable bit rate received in the RF module 110 to the optical transceiver 140 through a stream channel that is preferably allocated by the controller 120. Preferably, the MOST transceiver 130 uses a MOST 150 protocol that suitably supports a bandwidth of 150 Mbps and prepares a frame buffer that is capable of transmitting the variable rate, unlike the existing MOST 25.

In further embodiments, the optical transceiver 140 suitably converts the digital multimedia broadcasting signal transmitted from the MOST transceiver 130 into an optical signal. Preferably, the optical transceiver 140 optically transmits the digital multimedia broadcasting signal converted into the optical signal to the optical transceiver 140 of the head unit 200.

Accordingly, the head unit 200 preferably includes, but is not necessarily limited to, an optical transceiver 210, a MOST transceiver 230, an unified codec 240, a graphics controller 250, and a controller 220. Preferably, the optical transceiver 210 suitably receives the digital multimedia broadcasting signal converted into an optical signal from the optical transceiver 140 of the tuner 100. Further, the optical transceiver 210 suitably converts the digital multimedia broadcasting signal into an electrical digital multimedia broadcasting signal and sends to the MOST transceiver 230.

According to further preferred embodiments, the MOST transceiver 230 suitably receives the digital multimedia broadcasting signal from the optical receiver and then sends to the unified codec 240. Preferably, the unified codec 240 (for example, H264 codec) separately extracts an audio signal and a video signal from the digital multimedia broadcasting signal having a variable bit rate transmitted from the MOST transceiver 230

According to further embodiments of the present invention, the graphics controller 250 suitably receives the video signal from the unified codec 240 and then suitably performs a signal processing and the outputs the video signal through the display unit 260. Preferably, the MOST transceiver 230 suitably receives the audio signal from the unified codec 240 and sends it to the speaker 270 through the optical transceiver 140. Preferably, the controller 220 sends the transmission start request signal of digital multimedia broadcasting signal to the tuner 100. A preferred method for suitably receiving a digital multimedia broadcasting according to preferred embodiments of the present invention is described herein.

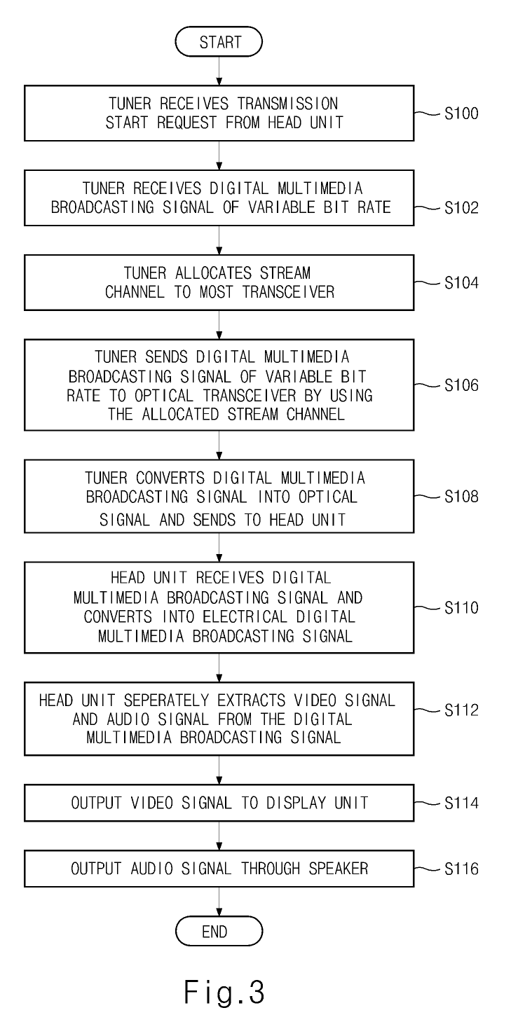

In one exemplary embodiment, for example as shown in FIG. 3, a flowchart shows a method of reception of a digital multimedia broadcasting of the present invention.

As shown in FIG. 3, firstly, the controller 220 of the head unit 200 preferably sends the transmission start request signal for digital multimedia broadcasting signal to the tuner 100 when receiving a digital multimedia broadcasting mode from a user through an additional key input unit. Preferably, in the case of receiving the transmission start request signal from the head unit 200 (S100), the RF module 110 of the tuner 100 suitably receives the digital multimedia broadcasting signal that is suitably made of variable bit rate from the broadcast station through the antenna (S102).

Preferably, the controller 120 of tuner 100 suitably allocates a plurality of stream channels to the MOST transceiver for the transmission of the digital multimedia broadcasting signal (S104). In further exemplary embodiments, the MOST transceiver 130 of tuner 100 suitably sends the digital multimedia broadcasting signal of variable bit rate received in the RF module 110 to the optical transceiver 140 by using the stream channel that is suitably allocated by the controller 120 (S106).

According to further preferred embodiments, the optical transceiver 140 of tuner 100 suitably converts the digital multimedia broadcasting signal transmitted from the MOST transceiver 130 into an optical signal and then suitably sends it to the head unit 200 (S108). Preferably, the optical transceiver 210 of the head unit 200 receives the digital multimedia broadcasting signal converted into an optical signal from the optical transceiver 140 of tuner 100 and converts into an electrical digital multimedia broadcasting signal (S110).

According to further exemplary embodiments, the MOST transceiver 230 of head unit 200 receives the digital multimedia broadcasting signal from the optical receiver and then sends it to the unified codec 240. Preferably, the unified codec 240 of head unit 200 separately extracts a video signal and an audio signal from the digital multimedia broadcasting signal transmitted from the MOST transceiver 230 (S112).

In further exemplary embodiments, the graphics controller 250 suitably receives the video signal from the unified codec 240 and then suitably controls to output by using the display unit 260 (S114). Preferably, the MOST transceiver 230 receives the audio signal from the unified codec 240 and then sends it to the speaker 270 through the optical transceiver 210 such that the speaker 270 outputs the audio signal (S116).

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A reception system for digital multimedia broadcasting, the reception system comprising:
a tuner that sends a digital multimedia broadcasting signal made of variable bit rate received from a broadcast station through a MOST transceiver; and
a head unit that separately extracts a video signal and an audio signal from the digital multimedia broadcasting signal of variable bit rate transmitted from the tuner, and outputs the video signal and the audio signal.

2. The reception system of claim 1, wherein the tuner comprises:
a RF module that receives the digital multimedia broadcasting signal made of variable bit rate from the broadcast station through an antenna;
a controller that receives a transmission start request signal of digital multimedia broadcasting signal from the head unit and allocates a plurality of stream channels to a MOST transceiver for the transmission of the digital multimedia broadcasting signal and generates a channel allocation confirmation signal;
a MOST transceiver that sends the digital multimedia broadcasting signal of variable bit rate received in the RF module to an optical transceiver by using the stream channel allocated by the controller; and
an optical transceiver that converts the digital multimedia broadcasting signal transmitted from the MOST transceiver into an optical signal and sends to the head unit.

3. The reception system of claim 1, wherein the head unit comprises:
an optical transceiver that receives the digital multimedia broadcasting signal converted into an optical signal from the optical transceiver of tuner to convert the digital multimedia broadcasting signal into an electrical digital multimedia broadcasting signal;
a controller that sends a transmission start request for digital multimedia broadcasting signal to the tuner and receives a channel allocation confirmation signal according to the transmission start request and allocates a plurality of stream channels to the MOST transceiver for the transmission of the digital multimedia broadcasting signal;
a MOST transceiver that receives a digital multimedia broadcasting signal from the optical receiver;
an unified codec that separately extracts an audio signal and a video signal from the digital multimedia broadcasting signal transmitted from the MOST transceiver;
a graphics controller receives the video signal from the unified codec and outputs the video signal by using a monitor,
wherein the MOST transceiver receives the audio signal from the unified codec and sends the audio signal to a speaker through an optical transceiver.

4. The reception system of claim 1, wherein the MOST transceiver comprises:
a plurality of stream channels that transmit the digital multimedia broadcasting signal; and
a control channel that sends a transmission start request signal and a channel allocation completion signal which is generated as the controller allocates a stream channel to the MOST transceiver.

5. The reception system of claim 1, wherein the MOST transceiver is made of a MOST 150 protocol.

6. A receiving method for digital multimedia broadcasting, the receiving method comprising:
(a) sending a digital multimedia broadcasting signal made of variable bit rate received from a broadcast station by making use of a MOST transceiver by a tuner; and
(b) separately extracting a video signal and an audio signal from the digital multimedia broadcasting signal of variable bit rate transmitted from the tuner, and outputs the video signal and the audio signal by a head unit.

7. The receiving method of claim 6, wherein the MOST transceiver is made of a MOST 150 protocol.

8. The receiving method of claim 6, wherein the step (a) comprises:
(a-1) receiving a transmission start request signal for digital multimedia broadcasting signal from the head unit;
(a-2) allocating a plurality of stream channels to the MOST transceiver for the transmission of the digital multimedia broadcasting signal and generating a channel allocation confirmation signal;
(a-3) receiving a digital multimedia broadcasting signal made of variable bit rate from the broadcast station through an antenna; and
(a-4) optically transmitting the received digital multimedia broadcasting signal of variable bit rate to the head unit by using the stream channel of MOST transceiver which is allocated by the controller.

9. The receiving method of claim 6, wherein the step (b) comprises:
(b-1) sending a transmission start request signal for digital multimedia broadcasting signal to the tuner;
(b-2) allocating a plurality of stream channels to the MOST transceiver for the transmission of the digital multimedia broadcasting signal;
(b-3) receiving a digital multimedia broadcasting signal converted into an optical signal from an optical transceiver of the tuner through a stream channel of MOST transceiver and converting the digital multimedia broadcasting signal into an electrical digital multimedia broadcasting signal;
(b-4) separately extracting an audio signal and a video signal from the electrical digital multimedia broadcasting signal; and
(b-5) outputting the video signal by using a monitor and sending the audio signal to a speaker.

10. A reception system for digital multimedia broadcasting, comprising:
a tuner, wherein the tuner sends a digital multimedia broadcasting signal made of variable bit rate through a MOST transceiver; and
a head unit.

11. The reception system for digital multimedia broadcasting of claim 10, wherein the variable bit rate is received from a broadcast station through a MOST transceiver.

12. The reception system for digital multimedia broadcasting of claim 10, wherein the head unit separately extracts a video signal and an audio signal from the digital multimedia broadcasting signal of variable bit rate transmitted from the tuner, and outputs the video signal and the audio signal.

13. A motor vehicle comprising the a reception system for digital multimedia broadcasting of claim 1.

14. A motor vehicle comprising the a reception system for digital multimedia broadcasting of claim 10.
